(19) United States
(12) Patent Application Publication
(10) Pub. No.: US 2021/0204744 A1
(43) Pub. Date: Jul. 8, 2021

(54) Dutch Oven Divider Assembly

(71) Applicant: Michael S. Glines, Taylorsville, UT (US)

(72) Inventor: Michael S. Glines, Taylorsville, UT (US)

(21) Appl. No.: 16/735,803

(22) Filed: Jan. 7, 2020

(51) Int. Cl. A47J 27/122

(52) U.S. Cl. CPC A47J 27/122

(57) ABSTRACT

A Dutch oven divider assembly includes a plurality of buckets that is each insertable into a Dutch oven. The buckets define a plurality of compartments in the Dutch oven to facilitate the Dutch oven to simultaneously cook a variety of foods. A coupler is attached to a respective one of the buckets. The coupler releasably engages an adjacent one of the buckets with respect to the respective bucket for attaching the respective bucket and the adjacent bucket together.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to divider devices and more particularly pertains to a new divider device for simultaneously cooking a variety of foods in a Dutch oven.

### (2) Description of Related Art Including Information Disclosed Under 37 CFR 1.97 and 1.98

The prior art relates to divider devices. The prior art discloses a variety of dividers that are positionable in a cooking pot for dividing an interior of the cooking pot into a plurality of compartments. The dividers generally include a plurality of walls that radiate outwardly from a center of the cooking pot. The prior art discloses a cooking pot that has a plurality of divider walls being integrated into the cooking pot to define a plurality of chambers in the cooking pot. None of the prior art disclosed claims a plurality of fluidly discrete containers that are insertable into a cooking pot.

### BRIEF SUMMARY OF THE INVENTION

An embodiment of the disclosure meets the needs presented above by generally comprising a plurality of buckets that is each insertable into a Dutch oven. The buckets define a plurality of compartments in the Dutch oven to facilitate the Dutch oven to simultaneously cook a variety of foods. A coupler is attached to a respective one of the buckets. The coupler releasably engages an adjacent one of the buckets with respect to the respective bucket for attaching the respective bucket and the adjacent bucket together.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a Dutch oven divider assembly according to an embodiment of the disclosure.

FIG. 2 is an exploded perspective view of an embodiment of the disclosure.

FIG. 3 is an exploded in-use view of an embodiment of the disclosure.

FIG. 4 is a top exploded view of an embodiment of the disclosure.

FIG. 5 is a top view of an alternative embodiment of the disclosure.

FIG. 6 is a perspective view of an alternative embodiment of the disclosure.

### DETAILED DESCRIPTION OF THE INVENTION

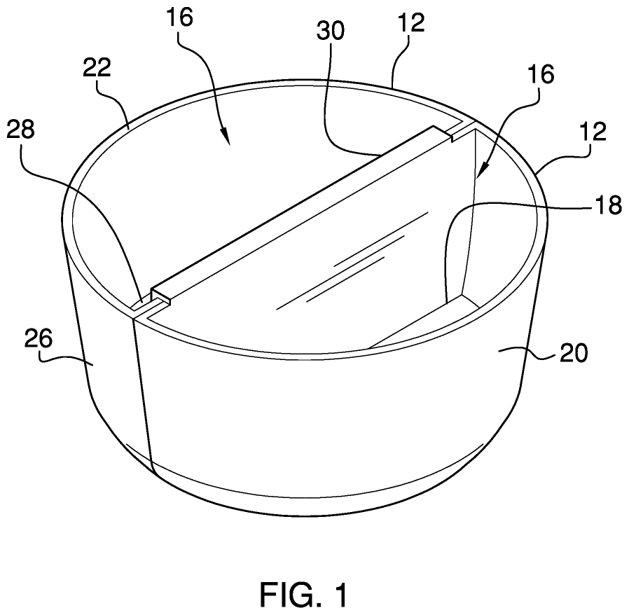

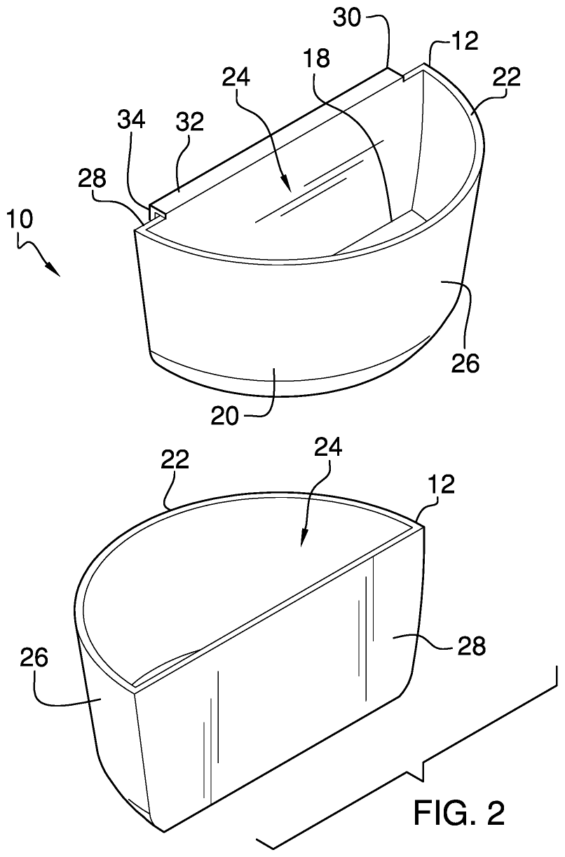

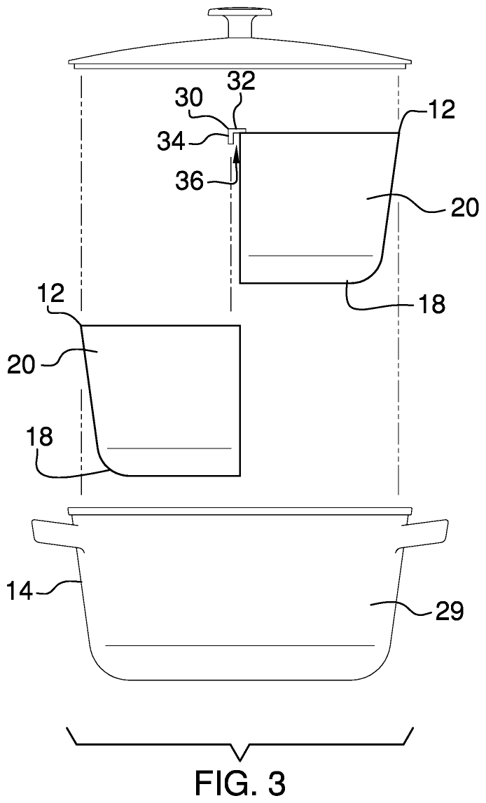

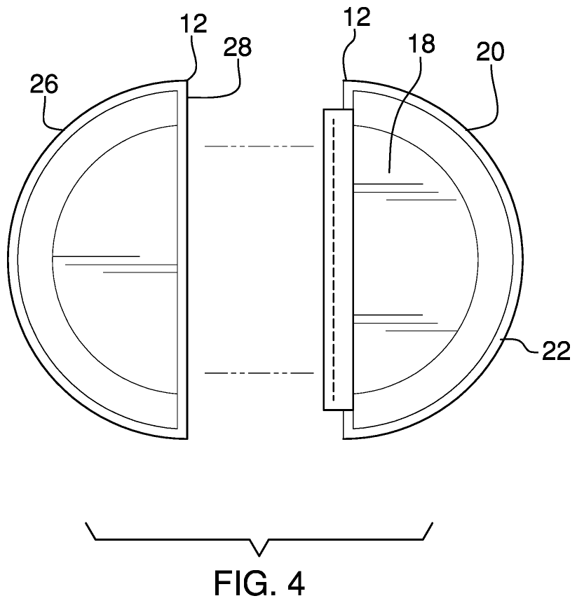

With reference now to the drawings, and in particular to FIGS. 1 through 6 thereof, a new divider device embodying the principles and concepts of an embodiment of the disclosure and generally designated by the reference numeral 10 will be described.

As best illustrated in FIGS. 1 through 6, the Dutch oven divider assembly 10 generally comprises a plurality of buckets 12 that is each of the buckets 12 is insertable into a Dutch oven 14. The buckets 12 can also be placed into any type of pot that is used for baking or the like. The buckets 12 conform to each other in the Dutch oven 14 to define a plurality of compartments 16 in the Dutch oven 14. In this way the plurality of buckets 12 facilitate the Dutch oven 14 to simultaneously cook a variety of foods. Moreover, each of the buckets 12 is fluidly discrete from each other when the buckets 12 are positioned in the Dutch oven 14 to inhibit the variety of foods from mixing with each other. Each of the buckets 12 is comprised of a thermally conductive material such that the buckets 12 are in thermal communication with the Dutch oven 14 for cooking the variety of foods.

Each of the buckets 12 has a bottom wall 18 and an outer wall 20 extending upwardly therefrom. The outer wall 20 has a distal edge 22 with respect to the bottom wall 18 to define an opening 24 into the buckets 12 and the outer wall 20 has a first side 26 and a second side 28. The first side 26 is concavely arcuate with respect to the second side 28 thereby facilitating the first side 26 to conform to curvature of an outer wall 29 of the Dutch oven 14. The second side 28 of the outer wall 20 of the buckets 12 abuts each other when the buckets 12 are positioned in the Dutch oven 14.

A coupler 30 is attached to respective one of the buckets 12 and the coupler 30 releasably engages an adjacent one of the buckets 12 with respect to the respective bucket 12. In this way the respective bucket 12 and the adjacent bucket 12 are attached together. The coupler 30 is positioned on the second side 28 of the outer wall 20 of the respective bucket 12. The coupler 30 comprises a leg 32 extending away from the distal edge 22 of the outer wall 20 corresponding to the second side 28. Additionally, the coupler 30 comprises a foot 34 that is spaced from and extends downwardly along the second side 28 to define a coupling space 36 between the foot 34 and the second side 28. The coupling space 36 insertably receives the distal edge 22 of the outer wall 20 corresponding to the second side 28 of the adjacent bucket 12.

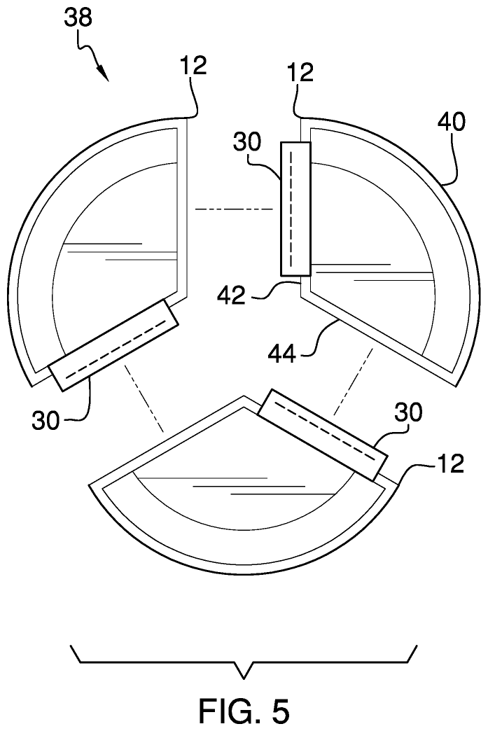

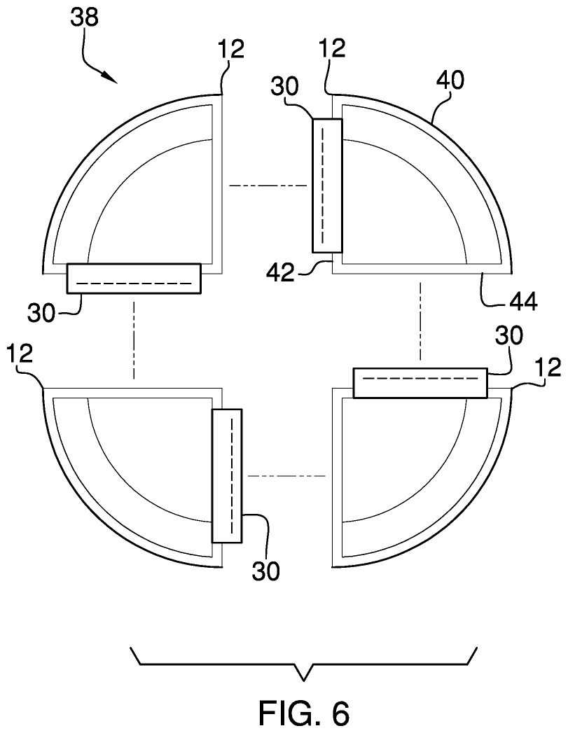

In an alternative embodiment 38 as is most clearly shown in FIGS. 5 and 6, the outer wall 20 of each of the buckets 12 has a primary side 40, a secondary side 42 and a tertiary side 44. The primary side 40 is concavely arcuate with respect to a center point of the bucket 12 such that the primary side 40 conforms to the curvature of the outer wall 29 of the Dutch oven 14. Additionally, the second side 28 intersects the tertiary side 44 at an angle such that each of the buckets 12 has a wedge shape. Continuing in the alternative embodiment 38, a plurality of the couplers 30 is each positioned on the secondary side 42 of the outer wall 20 of a respective one of the buckets 12. Each of the couplers 30 releasably engages the tertiary side 44 of the outer wall 20 of an adjacent one of the buckets 12 for attaching the plurality of buckets 12 together. As is most clearly shown in FIG. 5, the secondary side 42 and the tertiary side 44 may intersect at an obtuse angle. As is most clearly shown in FIG. 6, the secondary side 42 and the tertiary side 44 may intersect at a right angle.

In use, the plurality of buckets 12 is inserted into the Dutch oven 14 such that the coupler 30 engages the adjacent buckets 12. In this way a variety of food items can each be positioned in respective buckets 12 for cooking all of the food items together in the dutch over. Moreover, the buckets 12 keep the food items from mixing together while they are being cooked. In this way soups or other viscous food items can be cooked with meat, vegetables or other solid food items in the same Dutch oven 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A Dutch oven divider assembly being configured to divide a Dutch oven into a plurality of compartments for simultaneous cooking a variety of foods, said assembly comprising:
a plurality of buckets, each of said buckets being insertable into a Dutch oven, said buckets conforming to each other in the Dutch oven to define a plurality of compartments in the Dutch oven wherein said plurality of buckets is configured to facilitate the Dutch oven to simultaneously cook a variety of foods, each of said buckets being fluidly discrete from each other when said buckets are positioned in the Dutch oven wherein said buckets are configured to inhibit the variety of foods from mixing with each other, each of said buckets being comprised of a thermally conductive material such that said buckets are in thermal communication with the Dutch oven wherein said buckets are configured to cook the variety of foods, said plurality of buckets releasably engaging each other when said buckets are positioned in the Dutch oven; and
a coupler being attached to respective one of said buckets, said coupler releasably engaging an adjacent one of said buckets with respect to said respective bucket for attaching said respective bucket and said adjacent bucket together.

2. The assembly according to claim 1, wherein each of said buckets has a bottom wall and an outer wall extending upwardly therefrom, said outer wall having a distal edge with respect to said bottom wall to define an opening into said buckets, said outer wall having a first side and a second side.

3. The assembly according to claim 2, wherein said first side is concavely arcuate with respect to said second side thereby facilitating said first side to conform to curvature of an outer wall of the Dutch oven.

4. The assembly according to claim 2, wherein said second side of said outer wall of said buckets abuts each other when said buckets are positioned in the Dutch oven.

5. The assembly according to claim 2, wherein said coupler comprises a leg extending away from said distal edge of said outer wall corresponding to said second side and a foot being spaced from and extending downwardly along said second side to define a coupling space between said foot and said second side.

6. The assembly according to claim 5, wherein said coupling space insertably receives said distal edge of said outer wall corresponding to said second side of said adjacent bucket.

7. A Dutch oven divider assembly being configured to divide a Dutch oven into a plurality of compartments for simultaneous cooking a variety of foods, said assembly comprising:
a plurality of buckets, each of said buckets being insertable into a Dutch oven, said buckets conforming to each other in the Dutch oven to define a plurality of compartments in the Dutch oven wherein said plurality of buckets is configured to facilitate the Dutch oven to simultaneously cook a variety of foods, each of said buckets being fluidly discrete from each other when said buckets are positioned in the Dutch oven wherein said buckets are configured to inhibit the variety of foods from mixing with each other, each of said buckets being comprised of a thermally conductive material such that said buckets are in thermal communication with the Dutch oven wherein said buckets are configured to cook the variety of foods, said plurality of buckets releasably engaging each other when said buckets are positioned in the Dutch oven, each of said buckets having a bottom wall and an outer wall extending upwardly therefrom, said outer wall having a distal edge with respect to said bottom wall to define an opening into said buckets, said outer wall having a first side and a second side, said first side being concavely arcuate with respect to said second side thereby facilitating said first side to conform to curvature of an outer wall of the Dutch oven, said second side of said outer wall of said buckets abutting each other when said buckets are positioned in the Dutch oven; and
a coupler being attached to respective one of said buckets, said coupler releasably engaging an adjacent one of said buckets with respect to said respective bucket for attaching said respective bucket and said adjacent bucket together, said coupler being positioned on said second side of said outer wall of said respective bucket, said coupler comprising a leg extending away from said distal edge of said outer wall corresponding to said second side and a foot being spaced from and extending downwardly along said second side to define a coupling space between said foot and said second side, said coupling space insertably receiving said distal edge of said outer wall corresponding to said second side of said adjacent bucket.

8. The assembly according to claim 7, wherein said outer wall of each of said buckets has a primary side, a secondary side and a tertiary side, said primary side being concavely arcuate with respect to a center point of said bucket such that said primary side conforms to the curvature of the outer wall of the Dutch oven, said second side intersecting said tertiary side at an angle such that each of said buckets has a wedge shape.

9. The assembly according to claim 8, wherein a plurality of said couplers is provided, each of said couplers being positioned on said secondary side of said outer wall of a respective one of said buckets, each of said couplers releasably engaging said tertiary side of said outer wall of an adjacent one of said buckets for attaching said plurality of buckets together.

10. A Dutch oven divider system comprising:
a Dutch oven having an outer wall;
a plurality of buckets, each of said buckets being insertable into said Dutch oven, said buckets conforming to each other in said Dutch oven to define a plurality of compartments in said Dutch oven wherein said plurality of buckets is configured to facilitate said Dutch oven to simultaneously cook a variety of foods, each of said buckets being fluidly discrete from each other when said buckets are positioned in said Dutch oven wherein said buckets are configured to inhibit the variety of foods from mixing with each other, each of said buckets being comprised of a thermally conductive material such that said buckets are in thermal communication with said Dutch oven wherein said buckets are configured to cook the variety of foods, said plurality of buckets releasably engaging each other when said buckets are positioned in said Dutch oven, each of said buckets having a bottom wall and an outer wall extending upwardly therefrom, said outer wall having a distal edge with respect to said bottom wall to define an opening into said buckets, said outer wall having a first side and a second side, said first side being concavely arcuate with respect to said second side thereby facilitating said first side to conform to curvature of an outer wall of said Dutch oven, said second side of said outer wall of said buckets abutting each other when said buckets are positioned in said Dutch oven; and
a coupler being attached to respective one of said buckets, said coupler releasably engaging an adjacent one of said buckets with respect to said respective bucket for attaching said respective bucket and said adjacent bucket together, said coupler being positioned on said second side of said outer wall of said respective bucket, said coupler comprising a leg extending away from said distal edge of said outer wall corresponding to said second side and a foot being spaced from and extending downwardly along said second side to define a coupling space between said foot and said second side, said coupling space insertably receiving said distal edge of said outer wall corresponding to said second side of said adjacent bucket.
